(19) United States
(12) Patent Application Publication
(10) Pub. No.: US 2018/0056930 A1
(43) Pub. Date: Mar. 1, 2018

(54) MOVING DEVICE

(71) Applicant: KABUSHIKI KAISHA TOKAI-RIKA-DENKI-SEISAKUSHO, Aichi-ken (JP)

(72) Inventors: Tatsuhiro MURASAKI, Aichi-ken (JP); Takuhiro SAITO, Aichi-ken (JP); Yasunori HATA, Aichi-ken (JP); Yusuke WATADA, Aichi-ken (JP)

(21) Appl. No.: 15/687,048

(22) Filed: Aug. 25, 2017

(30) Foreign Application Priority Data
Aug. 29, 2016 (JP) 2016-167221

(51) Int. Cl. B60R 22/04

(52) U.S. Cl. CPC B60R 22/04

(57) ABSTRACT

In a lift-up buckle device, a slider and a shoe are provided at a seatbelt device. The slider and the shoe are moved by a drive screw that is driven by an output shaft of a motor. Here, a buffering body is provided at the output shaft, and concave portions are formed at corner portions of an inserted-into portion. Therefore, projecting portions which project-out into the inserted-into portion being formed at the corner portions of the inserted-into portion when the buffering body is molded can be suppressed, and corner portions of the output shaft interfering with the projecting portions can be suppressed. Accordingly, because rattling of the output shaft within the inserted-into portion can be suppressed, operating noise can be reduced.

### CROSS-REFERENCE TO RELATED APPLICATION

This application claims priority under 35 USC 119 from Japanese Patent Application No. 2016-167221, filed Aug. 29, 2016, the disclosure of which is incorporated by reference herein.

### BACKGROUND

### Field of the Invention

The present invention relates to a moving device in which a moving body is moved.

### Related Art

In the buckle moving device disclosed in Japanese Patent Application Laid-Open (JP-A) No. 2012-131360, a motor rotates a drive screw via a gear and a screw joint. The gear and the screw joint are connected via a joint damper that is elastically deformable.

Here, it is preferable to reduce operating noise in such a buckle moving device.

### SUMMARY

In consideration of the above-described circumstances, a moving device that can reduce operating noise is provided.

A moving device of a first aspect has: a moving body that is provided at a seatbelt device and that is configured to move; a driven body that is driven to move the moving body; a motive power section that drives the driven body; a buffering body that is interposed between the driven body and the motive power section; an inserted shaft that is provided at a driven body side of the buffering body or at a motive power section side of the buffering body; and an inserted-into portion that is provided at the buffering body, and into which the inserted shaft is inserted, a concave portion being provided at a corner portion of the inserted-into portion.

In a moving device of a second aspect, in the moving device of the first aspect, the concave portion is provided at an orthogonal surface of the inserted-into portion, the orthogonal surface being orthogonal to a central axis of rotation of the inserted shaft.

In a moving device of a third aspect, in the moving device of the first aspect or the second aspect, a peripheral surface of the concave portion is a curved surface.

In a moving device of a fourth aspect, the moving device of any one of the first aspect through the third aspect further has: an angular pillar portion that is provided at the inserted shaft, and that is formed in a shape of a polygonal pillar having a plurality of side surfaces; and a plurality of abutment surfaces that are provided at the inserted-into portion, and that respectively abut the plurality of the side surfaces of the angular pillar portion.

In a moving device of a fifth aspect, in the moving device of the fourth aspect, the concave portion is provided at, among the plurality of the abutment surfaces, at least an abutment surface that is furthest from the central axis of rotation of the inserted shaft, as seen from a direction of the central axis of rotation.

In a moving device of a sixth aspect, in the moving device of the fourth aspect or the fifth aspect, the concave portion is provided so as to be continuous from between adjacent abutment surfaces to between one of the adjacent abutment surfaces and the orthogonal surface of the inserted-into portion, the orthogonal surface being orthogonal to the central axis of rotation of the inserted shaft.

In the moving device of the first aspect, the moving body is provided at a seatbelt device. The motive power section drives the driven body, and the moving body is moved. The buffering body is provided (interposed) between the driven body and the motive power section. The inserted shaft is provided at the driven body side or at the motive power section side of the buffering body. The inserted shaft is inserted in the inserted-into portion of the buffering body.

Here, the concave portion(s) is(are) formed at the inserted-into portion at the region(s) corresponding to the corner portion(s) of the inserted shaft. Therefore, the corner portion(s) of the inserted shaft interfering with the region(s) of the inserted-into portion, the region(s) corresponding to the corner portion(s) of the inserted shaft, can be suppressed. Thus, because rattling of the inserted shaft within the inserted-into portion can be suppressed, operating noise can be reduced.

In the moving device of the second aspect, the concave portion is provided at the orthogonal surface, which is orthogonal to the central axis of rotation of the inserted shaft, of the inserted-into portion. Accordingly, the corner portion of the inserted shaft interfering with the corner portion, which is between the orthogonal surface and the abutment surface at the inserted-into portion, can be suppressed. Thus, because rattling of the inserted shaft within the inserted-into portion can be suppressed, operating noise can be reduced.

In the moving device of the third aspect, because the peripheral surface of the concave portion is configured by curved surface, stress concentrating at a specific region of the peripheral surface of the concave portion can be suppressed.

In the moving device of the fourth aspect, the angular pillar portion of the inserted shaft is formed in the shape of a polygonal pillar, and the plural abutment surfaces are provided at the inserted-into portion. The plural abutment surfaces respectively abut the plural side surfaces of the angular pillar portion. Therefore, the torque transmitting performance of the inserted shaft can be improved.

In the moving device of the fifth aspect, the concave portions are formed at, among the plural abutment surfaces, the abutment surfaces that are further (the furthest) from the central axis of rotation of the inserted shaft as seen from a direction of the central axis of rotation. In other words, the concave portions are not formed at the abutment surfaces that are nearer to the central axis of rotation of the inserted shaft, i.e., the abutment surfaces that receive much load from the angular pillar portion. Therefore, damage to the buffering body can be suppressed.

In the moving device of the sixth aspect, the concave portions are provided as to be continuous from “between adjacent abutment surfaces” to “between one of the adjacent abutment surfaces and the orthogonal surface of the inserted-into portion, the orthogonal surface being orthogonal to the central axis of rotation of the inserted shaft”. Therefore, there can be made to be more corner portions of the inserted shaft at which interference with the inserted-into portion is suppressed. Thus, because rattling of the inserted shaft at the interior of the buffering body can be suppressed more, operating noise can be reduced more.

### BRIEF DESCRIPTION OF THE DRAWINGS

An exemplary embodiment will be described in detail with reference to the following figures, wherein:

FIG. 1 is an exploded perspective view that is seen obliquely from a front and left side and shows a lift-up buckle device relating to an exemplary embodiment;

FIG. 2 is a cross-sectional view seen that is seen from the left and shows a portion of the lift-up buckle device relating to the exemplary embodiment;

FIG. 3 is an exploded perspective view showing an inserted shaft and a buffering body of the lift-up buckle device relating to the exemplary embodiment;

FIG. 4 is a cross-sectional view that is seen from the front and shows the inserted shaft and the buffering body of the lift-up buckle device relating to the exemplary embodiment;

FIG. 5A is a front view in which the inserted shaft of the lift-up buckle device relating to the exemplary embodiment is seen from the rear, FIG. 5B is a side view in which the inserted shaft is seen from the right with respect to FIG. 5A, and FIG. 5C is a plan view in which the inserted shaft is seen from above with respect to FIG. 5A.

### DETAILED DESCRIPTION

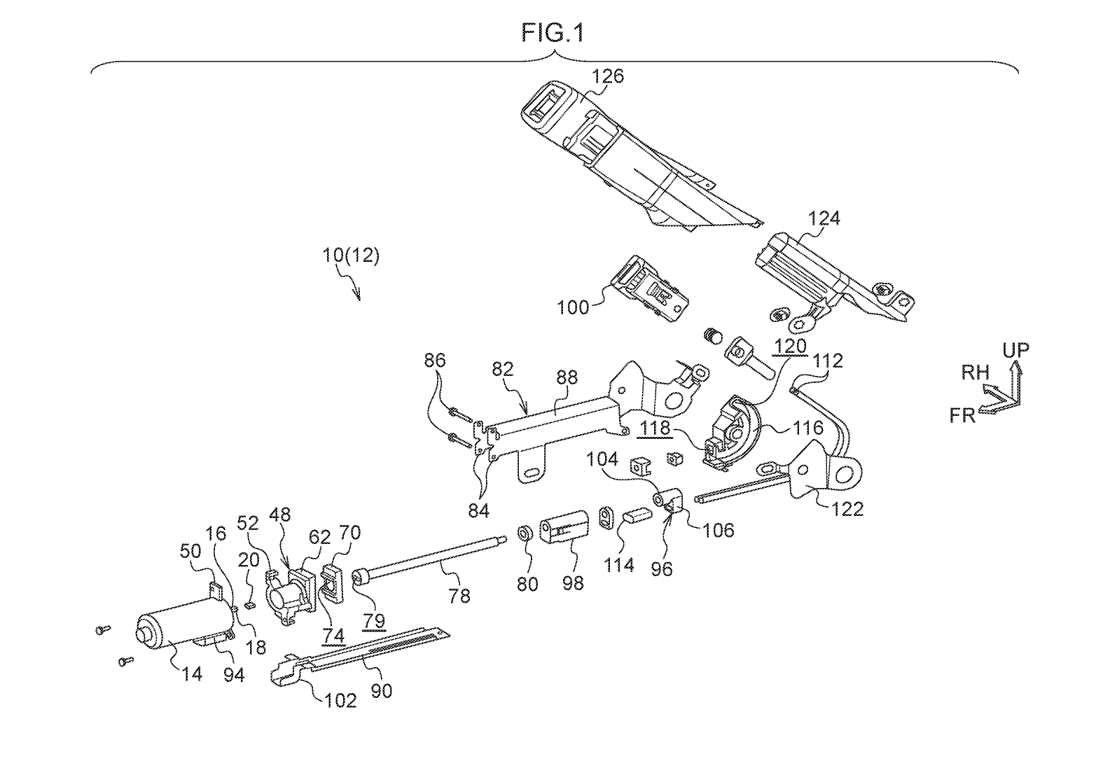

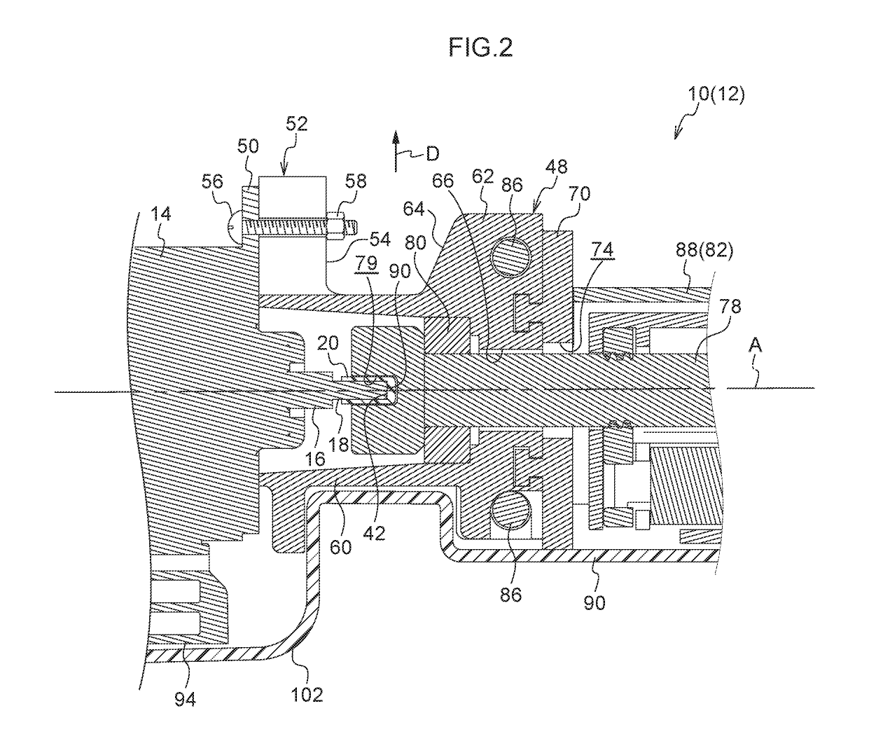

A lift-up buckle device 10, which serves as a moving device relating to an exemplary embodiment, is shown in FIG. 1 in an exploded perspective view seen obliquely from a front and left side. The lift-up buckle device 10 is shown in FIG. 2 in a cross-sectional view seen from the left. Note that, in the drawings, the front of the lift-up buckle device 10 is indicated by arrow FR, the right of the lift-up buckle device 10 is indicated by arrow RH, and the upper side of the lift-up buckle device 10 is indicated by arrow UP.

The lift-up buckle device 10 relating to the present exemplary embodiment structures a seatbelt device 12 of a vehicle (an automobile). The seatbelt device 12 is applied to a seat (not illustrated in the drawings) that is within a vehicle cabin. A seating sensor (not illustrated in the drawings) is provided at the seat. The seating sensor detects that a vehicle occupant is seated in the seat, and is electrically connected to a control device (not illustrated in the drawings). Further, the seat is made able to slide in the vehicle front and rear direction.

The seatbelt device 12 has a take-up device (not illustrated in the drawings). The take-up device is fixed to the vehicle transverse direction outer side and the lower side of the seat rear portion. A webbing (a seatbelt, not illustrated in the drawings) that is shaped as an elongated strip is taken-up from the proximal (base) end side thereof by the take-up device, and the webbing is pulled-out from the take-up device. Further toward the distal end side of the webbing than the take-up device, the webbing is movably passed-through a through-anchor (not illustrated in the drawings), and the through-anchor is supported at the vehicle transverse direction outer side and upper side of the seat rear portion. The distal end of the webbing is fixed to an anchor (not illustrated in the drawings), and the anchor is fixed to the vehicle transverse direction outer side and lower side of the seat rear portion. Further, between the through-anchor and the anchor, the webbing is movably passed-through a tongue (not illustrated in the drawings).

The lift-up buckle device 10 is fixed to the vehicle transverse direction inner side and lower side of the seat. The front, right and upper sides of the lift-up buckle device 10 are directed toward the front, right and upper sides of the vehicle, respectively. Further, the lift-up buckle device 10 can move integrally with the seat in the vehicle front and rear direction.

As shown in FIG. 1 and FIG. 2, a motor 14 that serves as a motive power section is provided at the front end portion of the lift-up buckle device 10. An output shaft 16, which serves as an inserted shaft, of the motor 14 projects-out rearward. The motor 14 is electrically connected to the aforementioned control device. Due to the motor 14 being driven forward and being driven reversely by control of the control device, the output shaft 16 is rotated in one direction and in another direction, respectively.

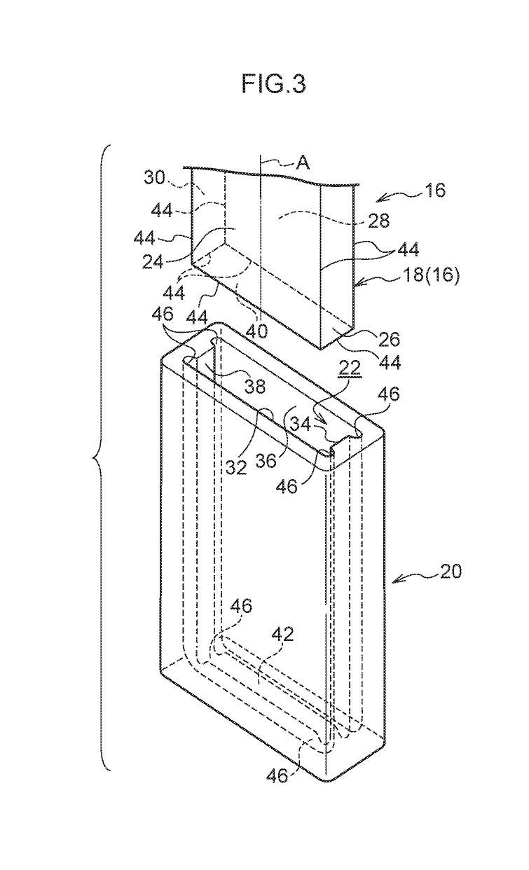

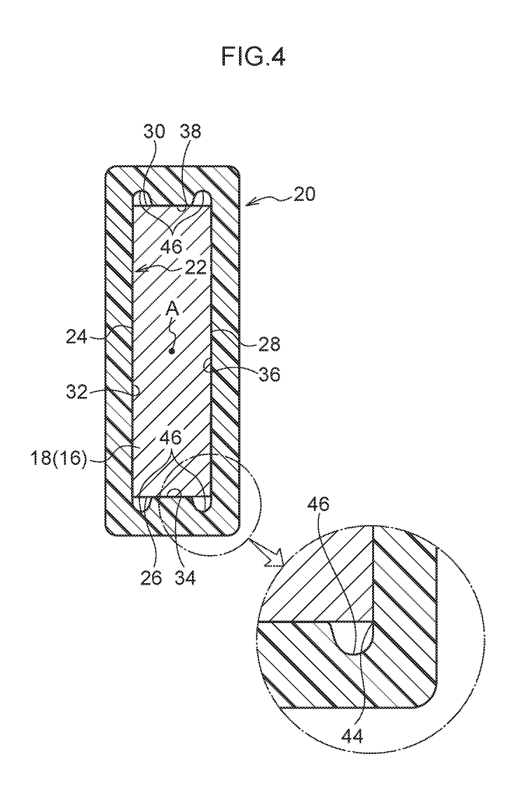

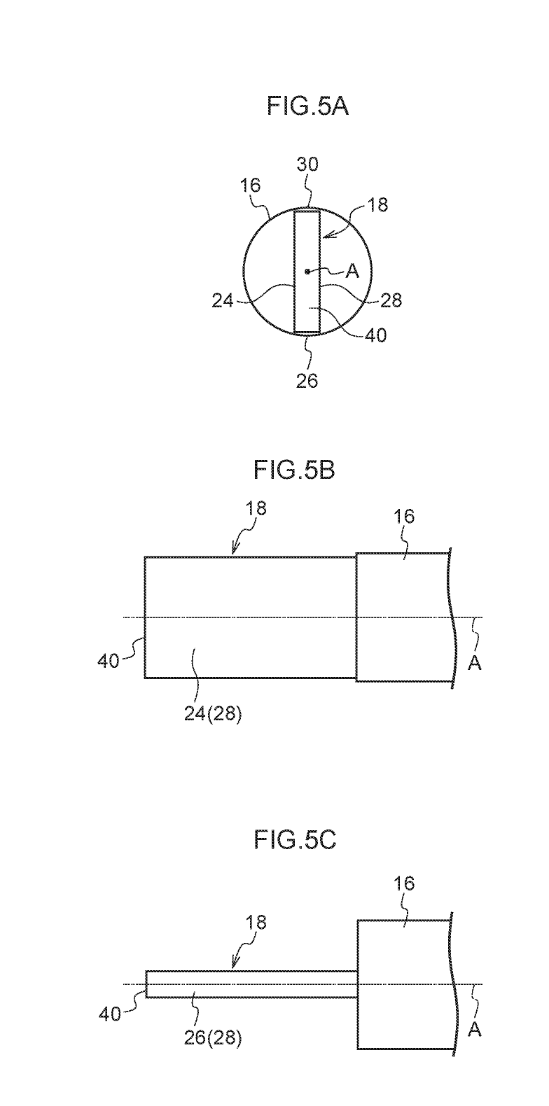

An angular pillar portion 18 (see FIGS. 5A through 5C), which is formed in the shape of an angular pillar that is rectangular as seen from the direction of rotational central axis A of the output shaft 16, is provided at the distal end portion of the output shaft 16. At least a portion of the angular pillar portion 18 is inserted (see FIG. 2) in an inserted-into portion 22 of a buffering body 20 (a joint) that is made of resin and is shown in FIG. 3. The buffering body 20 is formed substantially in the shape of an angular tube that has a bottom and whose motor 14 side is open. The inserted-into portion 22 has plural abutment surfaces 32, 34, 36, 38 that abut side surfaces 24, 26, 28, 30, respectively, of the angular pillar portion 18. Concretely, as shown in FIG. 4, the side surface 24 abuts the abutment surface 32, the side surface 26 abuts the abutment surface 34, the side surface 28 abuts the abutment surface 36, and the side surface 30 abuts the abutment surface 38, respectively. Further, distal end surface 40 of the angular pillar portion 18 shown in FIG. 3 abuts orthogonal surface 42 (bottom surface), which is orthogonal to the rotational central axis A of the output shaft 16, of the inserted-into portion 22 (see FIG. 2).

As shown in FIG. 3, concave portions 46 are provided at corner portions (inner side corner portions) that are between the abutment surfaces 32, 34, 36, 38 and the orthogonal surface 42 at the inserted-into portion 22, respectively. The concave portions 46 are disposed at the abutment surfaces 34, 38, which are further apart from the rotational central axis A as seen in the direction of the rotational axis of the output shaft 16 (see FIG. 4) (namely, at at least the abutment surfaces 34, 38, which are apart furthest from the rotational central axis A as seen in the direction of the rotational axis of the output shaft 16), and at the orthogonal surface 42, and are concave toward the outer side of the buffering body 20, and the peripheral surfaces thereof are curved surfaces. Further, the concave portion 46 that is formed at the corner portion between the abutment surface 32 and the abutment surface 34 (adjacent abutment surfaces), and the concave portion 46 that is formed at the corner portion between the abutment surface 32 and the orthogonal surface 42, and the concave portion 46 that is formed at the corner portion between the abutment surface 32 and the abutment surface 38 (adjacent abutment surfaces), are formed continuously. Similarly, the concave portion 46 that is formed at the corner portion between the abutment surface 36 and the abutment surface 34, and the concave portion 46 that is formed at the corner portion between the abutment surface 36 and the orthogonal surface 42, and the concave portion 46 that is formed at the corner portion between the abutment surface 36 and the abutment surface 38, are formed continuously. Further, the concave portion 46 is formed also at the corner portion between the abutment surface 34 and the orthogonal surface 42, and at the corner portion between the abutment surface 38 and the orthogonal surface 42.

As shown in FIG. 2, a housing 48, which is formed of an aluminum alloy which is covered by an oxide film, is disposed at the rear side of the motor 14. The motor 14 is assembled to the housing 48. Concretely, a motor fixing seat 50, whose plate thickness is in the front and rear direction, is provided at the motor 14, and a housing fastening portion 52 is provided at the upper side portion of the housing 48. The motor fixing seat 50 abuts the front surface of the housing fastening portion 52. A through-hole is formed so as to pass-through the motor fixing seat 50 in the plate thickness direction thereof, and a through-hole is formed so as to pass through the housing fastening portion 52. A tapping 56 is inserted into the through-hole of the motor fixing seat 50 and the through-hole of the housing fastening portion 52 from the front side and parallel to the rotational central axis A. A nut 58 is screwed-together with the tapping 56, and the nut 58 abuts a rear surface 54 of the housing fastening portion 52. Note that the rear surface 54 of the housing fastening portion 52 is formed perpendicular to the rotational central axis A.

A supporting tube 60 that is cylindrical is provided at the front side portion of the housing 48. The output shaft 16 of the motor 14 and the buffering body 20 are coaxially inserted within the supporting tube 60.

A stop block 62 that is substantially parallelepiped is provided at the rear end portion of the housing 48. An inclined portion 64 is provided integrally at the upper side of the stop block 62. The inclined portion 64 faces the housing fastening portion 52 in the front and rear direction. The inclined portion 64 is inclined toward the rear side while moving away from the rotational central axis A. Note that the portion, which is from the housing fastening portion 52 to the inclined portion 64, of the present housing 48 is formed by molding in which mold release direction D is a direction parallel to the rear surface 54 of the housing fastening portion 52, and the inclined portion 64 is inclined with respect to the mold release direction D.

An insert-through hole 66 that is circular is formed to pass-through the central portion of the stop block 62. The insert-through hole 66 communicates coaxially with the interior of the supporting tube 60. The diameter of the insert-through hole 66 is smaller than the diameter of the interior of the supporting tube 60.

A damper 70 that is substantially rectangular plate shaped is assembled to the rear side of the housing 48. The damper 70 is made of rubber, and is elastic and insulating. A through-hole 74 that is circular is formed so as to pass-through the central portion of the damper 70. The through-hole 74 communicates coaxially with the insert-through hole 66 of the stop block 62.

A drive screw 78, which serves as a driven body and is made of metal and is substantially solid cylindrical, is inserted coaxially within the supporting tube 60 of the housing 48, in the insert-through hole 66 and in the through-hole 74 of the damper 70. The drive screw 78 extends rearward from the damper 70. A vicinity of the front end of the drive screw 78 is rotatably fit-together with the interior of a bearing 80 that is cylindrical and made of metal, and the bearing 80 is fixed within the supporting tube 60. A connection hole 79 is formed in the front end of the drive screw 78. The connection hole 79 extends in the axial direction of the drive screw 78, and the above-described buffering body 20 is fit therein. Therefore, the output shaft 16 of the motor 14 is connected via the buffering body 20 to the front end of the drive screw 78, and the drive screw 78 is rotated integrally with the output shaft 16 and the buffering body 20. Further, a male screw is formed at the outer periphery of the drive screw 78, except for at the front end portion and the rear end portion thereof.

A rail 82, which is made of metal and serves as a guide body, is disposed at the rear side of the housing 48. As shown in FIG. 1, a pair of assembly plates 84, which are substantially shaped as elongated, rectangular plates, are provided at the front end of the rail 82. The assembly plates 84 are disposed at the left side and the right side of the stop block 62 of the housing 48. Bolts 86 are passed-through the upper end portions and lower end portions of the pair of assembly plates 84 and the stop block 62 in the left and right direction. The rail 82 is assembled to the stop block 62 due to unillustrated nuts being screwed-together with the bolts 86, and the stop block 62 and the pair of assembly plates 84 being nipped between the head portions of the bolts 86 and the nuts.

A rail portion 88, that serves as a guide portion and is shaped as an elongated plate having a U-shaped cross-section, is provided at the rear side of the pair of assembly plates 84. The interior of the rail portion 88 opens to the lower side. The left wall and the right wall of the rail portion 88 are integral with the assembly plates 84 respectively, and the damper 70 is disposed between the upper wall of the rail portion 88 and the rear surface of the stop block 62 of the housing 48. The drive screw 78 is accommodated within the rail portion 88, and the rail portion 88 is disposed parallel to the drive screw 78.

A rail cover 90, which serves as an additional member and is made of resin and is substantially shaped as an elongated, rectangular plate, is fixed to the lower sides of the housing 48 and the rail portion 88. The rail cover 90 covers the housing 48 and the interior of the rail portion 88 from the lower side.

A protecting portion 102 from obstacles is provided integrally with the front side of the rail cover 90. The protecting portion 102 from obstacles covers the rear side, the lower side, the left side and the right side of a motor terminal 94 that is at the lower side of the rear portion of the motor 14. The rear side of the protecting portion 102 from obstacles is structured by a curved surface that is rounded.

A slider 96, which is made of metal and serves as a moving member that structures a moving body, is disposed within the rail portion 88. An engaging portion 104 that is substantially cylindrical is provided at the upper side portion of the slider 96. A female screw is formed at the inner peripheral surface of the engaging portion 104. The drive screw 78 is coaxially inserted-through the interior of the engaging portion 104, and the female screw is screwed-together with the male screw of the drive screw 78. A fixing portion 106 that is substantially parallelepiped is provided integrally with the rear side portion of the engaging portion 104. The fixing portion 106 projects-out from the engaging portion 104 toward the lower side.

A shoe 98, which is made of resin and serves as a peripheral member that structures the moving body, is provided at the periphery of the slider 96. The interior of the shoe 98 opens toward the rear side. The engaging portion 104 and the fixing portion 106 at the slider 96 are accommodated within the shoe 98.

The left wall and the right wall of the shoe 98 abut the left wall and the right wall of the rail portion 88 of the rail 82, respectively. Due thereto, movement of the shoe 98 in the left and right direction is restricted, and rotation of the shoe 98 and the slider 96 around the drive screw 78 with respect to the rail portion 88 is restricted. Due to the drive screw 78 being rotated, the shoe 98 and the slider 96 are moved integrally in the front and rear direction while being guided by the rail portion 88.

The proximal end portions (front side end portions) of a pair of wires 112 that serve as a connecting member are passed-through the fixing portion 106 of the slider 96. The proximal end portions of the pair of wires 112 are fixed to the fixing portion 106 by caulking or the like of the fixing portion 106, and the pair of wires 112 can move integrally with the slider 96. A piece 114 is fixed to the pair of wires 112 at the front side of the fixing portion 106. The piece 114 is accommodated within the shoe 98.

A wire guide 116, which is block-shaped and made of metal and serves as a guiding member, is fixed to the rear end of the rail portion 88 of the rail 82. The wire guide 116 is formed substantially in the shape of a fan as seen in side view. A shaft supporting hole 118 is formed in the front end of the lower portion of the wire guide 116, and the rear end portion of the drive screw 78 is rotatably supported in the shaft supporting hole 118. A guide groove 120 is formed in the wire guide 116, and the guide groove 120 opens to the left side. The guide groove 120 is curved as seen in side view. The lower end portion of the guide groove 120 opens to the front side, and the upper end portion of the guide groove 120 opens in a direction of heading toward the front side while heading toward the upper side. The pair of wires 112 are inserted-through the guide groove 120. The portions, which are further toward the proximal end side than the wire guide 116, of the pair of wires 112 extend in the front and rear direction. The portions, which are further toward the distal end side than the wire guide 116, of the pair of wires 112 extend in a direction of heading toward the front side while heading toward the upper side. A cover plate 122 that is plate-shaped and made of metal is fixed to the left side of the wire guide 116. The cover plate 122 closes-off the left side of the guide groove 120.

The proximal end portion of a lower cover 124, which is tube-shaped and made of rubber for example, is mounted to the upper portion of the wire guide 116. The lower cover 124 extends in the direction heading toward the front side while heading toward the upper side. The interior of the lower cover 124 communicates with the upper end portion of the guide groove 120 of the wire guide 116. The pair of wires 112 are inserted through the interior of the lower cover 124.

The distal end side (the upper side and front side) of the lower cover 124 is inserted within a buckle cover 126 that is tube-shaped and made of resin for example. The buckle cover 126 is hard as compared with the lower cover 124. The buckle cover 126 is slidable along the lower cover 124, and the pair of wires 112 are inserted within the buckle cover 126.

A buckle 100 that serves as an interlocked body is fixed within the buckle cover 126. The distal end portions (the rear side end portions) of the pair of wires 112 are connected to the buckle 100. The buckle cover 126 exposes the buckle 100 at the distal end side (the upper side and the front side). The aforementioned tongue can be attached to and detached from the buckle 100. A buckle switch (not illustrated in the drawings) is provided at the buckle 100. The buckle switch detects that the tongue is attached to the buckle 100, and is electrically connected to the aforementioned control device.

Operation of the present exemplary embodiment is described next.

In the lift-up buckle device 10 of the above-described structure, when a vehicle occupant is not seated in the seat (when the seating sensor does not detect that a vehicle occupant is seated in the seat), the slider 96 and the shoe 98 are disposed at the front portions of the drive screw 78 and the rail 82, and the buckle cover 126 and the buckle 100 are disposed at a housed position that is at the lower side and the rear side.

When a vehicle occupant is seated in the seat (when the seating sensor detects that a vehicle occupant is seated in the seat), due to control of the control device, the motor 14 is driven forward, and the output shaft 16, the buffering body 20 and the drive screw 78 are rotated in one direction. Due thereto, the slider 96 and the screw 98 are moved toward the rear side while being guided by the rail portion 88 of the rail 82. Therefore, due to the pair of wires 112 being moved toward the distal end side integrally with the slider 96, the buckle cover 126 and the buckle 100 are moved toward the upper side and the front side, and are disposed at a raised position. Moreover, the webbing is pulled out from the take-up device, and the tongue of the webbing is attached to the buckle 100. Because the tongue is attached to the buckle 100 that is disposed at the raised position, the tongue can easily be attached to the buckle 100.

When the tongue is attached to the buckle 100 (when the buckle switch detects that the tongue is attached to the buckle 100), due to control of the control device, the motor 14 is driven reversely, and the output shaft 16, the buffering body 20 and the drive screw 78 are rotated in another direction. Due thereto, the slider 96 and the shoe 98 are moved toward the front side while being guided by the rail portion 88 of the rail 82. Therefore, due to the pair of wires 112 being moved toward the proximal (base) end side integrally with the slider 96, the buckle cover 126 and the buckle 100 are moved to the lower side and the rear side, and are disposed at the housed position. Due thereto, the webbing is applied to the vehicle occupant due to the tongue being moved to the lower side and the rear side together with the buckle 100.

Here, the buffering body 20 is provided at the distal end portion of the output shaft 16, and the concave portions 46 are formed at the corner portions of the inserted-into portion 22 of the buffering body 20. Therefore, at the time when the buffering body 20 is molded, projecting portions that project-out toward inside of the inserted-into portion 22 being formed at the corner portions of the inserted-into portion 22 can be suppressed, and corner portions 44 (outer side corner portions) of the output shaft 16 interfering with such projecting portions can be suppressed. Accordingly, because rattling of the output shaft 16 within the inserted-into portion 22 due to the corner portions 44 of the output shaft 16 interfering with such projecting portions can be suppressed, operating noise that is due to rattling can be reduced.

Further, due to the concave portions 46 being formed at the buffering body 20 that is made of resin, the concave portions 46 can be formed simultaneously at the time of molding the buffering body 20. Accordingly, the number of processing steps can be reduced as compared with a case in which chamfered portions are formed by cutting at the corner portions 44 of the output shaft 16 in order to prevent interference between the corner portions 44 of the output shaft 16 and such projecting portions of the corner portions of the inserted-into portion 22. Therefore, costs can be kept down.

Moreover, the concave portions 46 are formed in the orthogonal surface 42 that is orthogonal to the rotational central axis A of the output shaft 16 at the insert-into portion 22, and the concave portions 46 are formed in, of the plural abutment surfaces 32, 34, 36, 38 that correspond to the angular pillar portion 18, the abutment surfaces 34, 38 that are far from the rotational central axis A as seen in the direction of the rotational axis of the output shaft 16 as shown in FIG. 4. Accordingly, damage to the buffering body 20 can be suppressed because the concave portions 46 are not formed in the abutment surfaces 32, 36 whose surface area is large and that receive much load from the angular pillar portion 18 because they are nearer to the rotational central axis A.

Moreover, because the peripheral surfaces of the concave portions 46 are configured by curved surfaces, stress concentrating at a specific region of the peripheral surface of the concave portion 46 can be suppressed, and damage to the buffering body 20 can be suppressed.

Further, the output shaft 16 is formed in the shape of an angular pillar, and the plural abutment surfaces 32, 34, 36, 38, which respectively abut the side surfaces 24, 26, 28, 30 of the angular pillar portion 18, are provided at the inserted-into portion 22. Therefore, the torque transmitting performance of the output shaft 16 can be improved.

Moreover, as shown in FIG. 3, the concave portion 46 that is formed at the corner portion between the abutment surface 32 and the abutment surface 34, and the concave portion 46 that is formed at the corner portion between the abutment surface 32 and the orthogonal surface 42, and the concave portion 46 that is formed at the corner portion between the abutment surface 32 and the abutment surface 38, are formed in continuation. Similarly, the concave portion 46 that is formed at the corner portion between the abutment surface 36 and the abutment surface 34, and the concave portions 46 that is formed at the corner portion between the abutment surface 36 and the orthogonal surface 42, and the concave portion 46 that is formed at the corner portion between the abutment surface 36 and the abutment surface 38, are formed in continuation. Further, the concave portion 46 is formed also at the corner portion between the abutment surface 34 and the orthogonal surface 42, and at the corner portion between the abutment surface 38 and the orthogonal surface 42. Accordingly, such projecting portions that project-out toward inside of the inserted-into portion 22 being formed at the corner portions, which correspond to all of the corner portions 44 of the output shaft 16, of the inserted-into portion 22 can be suppressed, and all of the corner portions 44 of the output shaft 16 interfering with these projecting portions is suppressed. Thus, because rattling of the output shaft 16 within the inserted-into portion 22 can be suppressed, operating noise due to rattling can be reduced even more.

Still further, as shown in FIG. 2, the inclined portion 64 of the housing 48 is inclined toward the rear side with respect to the mold release direction D of the housing 48. Accordingly, the rear surface 54 of the housing fastening portion 52, which faces this inclined portion 64 in the front and rear direction, can be formed substantially perpendicularly to the rotational central axis A. Due thereto, the rear surface 54 of the housing fastening portion 52 at which the nut 58 is provided can be set orthogonally to the direction of insertion of the tapping 56 (a direction parallel to the rotational central axis A). Therefore, the tapping 56 can be stably screwed-together with the nut 58.

Further, the protecting portion 102 from obstacles of the rail cover 90 covers the rear side, the lower side, the left side and the right side of the motor terminal 94. Accordingly, in a case in which there is an unillustrated floor carpet between the lift-up buckle device 10 and the floor panel, or in a case in which there is an unillustrated dropped object between the seat and an unillustrated center console and at the rear side of the motor terminal 94, the protecting portion 102 from obstacles first abuts the floor carpet or the dropped object at the time when the lift-up buckle device 10 moves following the sliding of the seat. Therefore, direct contact of the floor carpet or the dropped object with the motor terminal 94 can be restricted, and the motor terminal 94 can be protected. Further, by forming the rear side of the protecting portion 102 from obstacles in R shape (in a rounded shape), the lift-up buckle device 10, and accordingly the seat, can be moved while moving the carpet or the dropped object toward the lower side.

Moreover, the buffering body 20 is formed of resin, and the housing 48 is formed of an aluminum alloy that is covered by an oxide film. Therefore, in a case in which static electricity from the vehicle occupant flows to the buckle 100, the wires 112, and the drive screw 78, static electricity can be prevented from flowing to the motor 14 at the buffering body 20 and the housing 48 that are insulators. Due thereto, damage to the motor 14 due to static electricity can be prevented.

Note that, in the present exemplary embodiment, the distal end portion of the output shaft 16 is formed in the shape of an angular pillar due to the angular pillar portion 18 being provided. However, the present exemplary embodiment is not limited to this, and the distal end portion of the output shaft 16 may be formed in the shape other than angular pillar.

Note that, in the present exemplary embodiment, it is possible that the inserted shaft and the angular pillar portion are formed at the drive screw 78 side, and the connection hole is formed at the motor 14 side and the buffering body 20 is fit in this connection hole.

Although the exemplary embodiment has been described above, it is not limited to the above, and can of course be implemented by being modified in various ways other than the above within a scope that does not depart from the gist thereof.

What is claimed is:

1. A moving device comprising:
a moving body that is provided at a seatbelt device and that is configured to move;
a driven body that is driven to move the moving body;
a motive power section that drives the driven body;
a buffering body that is interposed between the driven body and the motive power section;
an inserted shaft that is provided at a driven body side of the buffering body or at a motive power section side of the buffering body; and
an inserted-into portion that is provided at the buffering body, and into which the inserted shaft is inserted, a concave portion being provided at a corner portion of the inserted-into portion.

2. The moving device of claim 1, wherein the concave portion is provided at an orthogonal surface of the inserted-into portion, the orthogonal surface being orthogonal to a central axis of rotation of the inserted shaft.

3. The moving device of claim 1, wherein a peripheral surface of the concave portion is a curved surface.

4. The moving device of claim 2, wherein a peripheral surface of the concave portion is a curved surface.

5. The moving device of claim 1, further comprising:
an angular pillar portion that is provided at the inserted shaft, and that is formed in a shape of a polygonal pillar having a plurality of side surfaces; and
a plurality of abutment surfaces that are provided at the inserted-into portion, and that respectively abut the plurality of the side surfaces of the angular pillar portion.

6. The moving device of claim 2, further comprising:
an angular pillar portion that is provided at the inserted shaft, and that is formed in a shape of a polygonal pillar having a plurality of side surfaces; and
a plurality of abutment surfaces that are provided at the inserted-into portion, and that respectively abut the plurality of the side surfaces of the angular pillar portion.

7. The moving device of claim 5, wherein the concave portion is provided at, among the plurality of the abutment surfaces, at least an abutment surface that is furthest from the central axis of rotation of the inserted shaft, as seen from a direction of the central axis of rotation.

8. The moving device of claim 5, wherein the concave portion is provided at, among the plurality of the abutment surfaces, at least an abutment surface that is furthest from the central axis of rotation of the inserted shaft, as seen from a direction of the central axis of rotation.

9. The moving device of claim 6, wherein the concave portion is provided so as to be continuous from between adjacent abutment surfaces to between one of the adjacent abutment surfaces and the orthogonal surface of the inserted-into portion, the orthogonal surface being orthogonal to the central axis of rotation of the inserted shaft.

10. The moving device of claim 8, wherein the concave portion is provided at, among the plurality of the abutment surfaces, at least an abutment surface that is furthest from the central axis of rotation of the inserted shaft, as seen from a direction of the central axis of rotation.
